(19) United States
(12) Patent Application Publication
(10) Pub. No.: US 2004/0211069 A1
(43) Pub. Date: Oct. 28, 2004

(54) Cake cutter

(76) Inventor: Donna Tuttle, Middlesex, NJ (US)

Correspondence Address: Mr. Walter J. Tencza Jr., Suite 3, 10 Station Place, Metuchen, NJ, 08840, US

(21) Appl. No.: 10/421,266

(22) Filed: Apr. 23, 2003

(51) Int. Cl. A21C 5/08

(52) U.S. Cl. 30/302; 30/114

(57) ABSTRACT

A first device, having a plurality of sections, can be placed over a cake and when pressure is applied to the first device, the first device cuts the cake into a plurality of pieces corresponding to the plurality of sections. The plurality of sections may be substantially the same size and shape. A second device is also provided which includes a handle. The second device can be attached to or detached from the first device. A person may apply pressure to the first device by gripping or grabbing the handle of the second device and pushing downwards to cause the cake to be cut. A third device having a different shape from the first device, may be attached to the second or handle device.

### FIELD OF THE INVENTION

This invention relates to improved methods and apparatus concerning cutting cakes.

### BACKGROUND OF THE INVENTION

Typically in the prior art one cuts one piece from a whole cake, serves the piece and then cuts another piece from the whole cake. This can be a slow and tedious process. Also because each piece of cake is cut one at a time, it is difficult to achieve substantial uniformity for a plurality of pieces of cake.

Various cake cutters or dividers are known in the art, such as disclosed in E. Zimmerly, Des. Pat. No. 114,372; Fuenzalida, U.S. Pat. No. 5,129,159; and Parraga, U.S. Pat. No. 2,403,190. However, these cake cutters or dividers have drawbacks such as not being adjustable for cutting different size cakes.

### SUMMARY OF THE INVENTION

The present invention in one embodiment provides an apparatus comprising: a first device comprised of a plurality of sections. The first device can be placed over a cake and when pressure is applied to the first device, the first device cuts the cake into a plurality of pieces corresponding to the plurality of sections. The plurality of sections may be substantially the same size and shape.

The apparatus may be further comprised of a second device, which includes a handle. The second device can be attached to or detached from the first device. A person may apply pressure to the first device by gripping or grabbing the handle of the second device and pushing downwards to cause the cake to be cut. The first device may be any shape, such as circular, rectangular or heart shaped. The first device may have a perimeter wall, which corresponds in shape to a particular cake.

The apparatus may include a third device comprised of a plurality of sections. Like the first device, the third device when placed over a cake and when pressure is applied, the third device may cut the cake into a plurality of pieces corresponding to the plurality of sections. The third device may be of a different shape from the first device. For example, the first device may be circular shaped while the third device may be rectangular shaped. Either the first or the third device may be attached or detached from the second device or handle device.

The present invention in one or more embodiments includes a method of placing a first device comprised of a plurality of sections over a first cake and applying pressure to the first device to cause the first device to cut the first cake into a plurality of pieces corresponding to the plurality of sections of the first device. The method may include attaching the first device to a second device or handle device. The method may include detaching the first device from the second device or handle device and attaching a third device to the second device or handle device. The third device would then be used to cut a cake into a plurality of pieces. The first and third devices may each have a different shape.

### BRIEF DESCRIPTION OF THE DRAWINGS

FIG. 1 shows a perspective view of an apparatus in accordance with a first embodiment of the present invention;

FIG. 2 shows a perspective view of the apparatus of FIG. 1 connected together and a cake;

FIG. 3 shows a perspective view of a device in accordance with another embodiment of the present invention;

FIG. 4 shows a top view of the device of FIG. 3; and

FIG. 5 shows a top view of another device in accordance with another embodiment of the present invention.

### DETAILED DESCRIPTION OF THE DRAWINGS

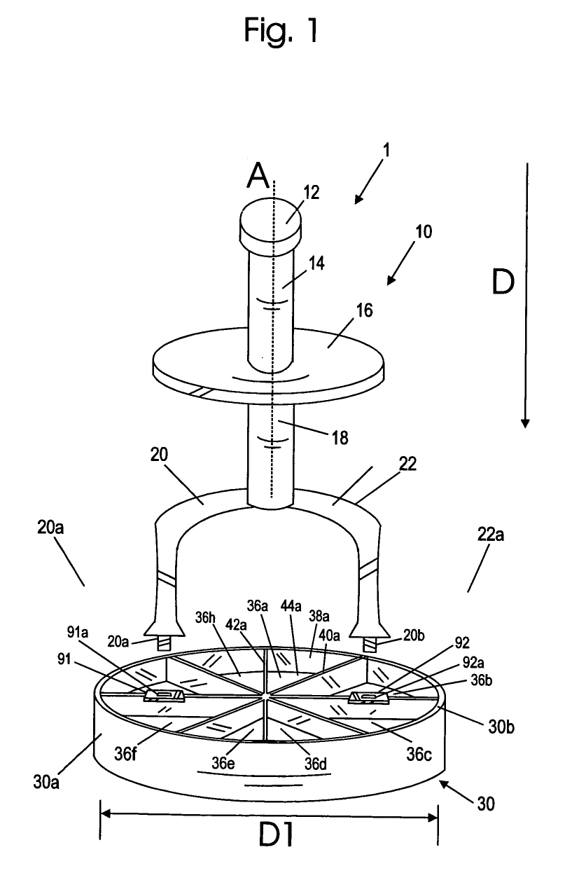

FIG. 1 shows a perspective view of an apparatus 1. The apparatus 1 is comprised of a device 10 and a device 30.

The device 10 is comprised of a knob 12, members 14, 16, and 18, and legs 20 and 22. The legs 20 and 22 terminate in extensions in protrusions 20a and 20b. The extensions or protrusions 20a and 20b may be rods, pegs, screws, or some other type of solid member. The member 14 may be a solid cylindrical rod. The member 16 may be a flat disc. The member 16 may be used to support an individual's hand while that hand is grasping the member or handle 14. The member 18 may be a solid cylindrical rod. The knob 12 may be fixed to the member 14, which is fixed to the member 16. The member 16 may be fixed to the member 18.

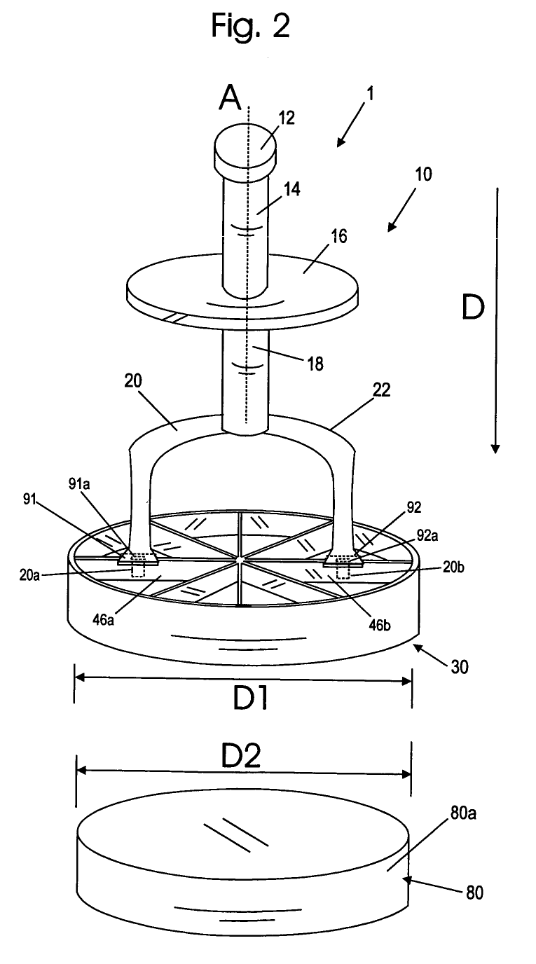

The device 30 may be comprised of eight sections, which include sections 36a, 36b, 36c, 36d, 36e, 36f, 36g, and 36h. Each section is substantially the same, therefore section 36a will only be described in detail. Section 36a has an opening 44a, which is bound by walls 38a, 40a, and 42a. The wall 38a may be arc shaped and may be part of an overall perimeter wall 30a. The perimeter wall 30a may be in the shape of a whole cake, which is to be cut by the apparatus 1. For example, with reference to FIG. 2, a circular whole cake, such as cake 80, would be cut by the circular shaped second device 30. The circular whole cake 80 would typically have a diameter, D2, which is typically slightly less than the inner diameter D1 of the circular second device 30. The inner diameter D1 may be seven to twelve inches or some other size depending on the size of the cake to be cut. The present invention in one embodiment includes the combination of appropriately sized cake 80 and the device 30.

The device 30 may include brackets 91 and 92 which are fixed to or are otherwise connected to and made part of the device 30. The brackets 91 and 92 may include slots 91a and 92a. In operation, the device 10 is attached to the device 30 by inserting the protrusions 20a and 20b into the slots 91a and 92a, respectively, as shown by FIGS. 1 and 2. FIG. 2 shows dashed lines which show the locations of the protrusions 20a and 20b after they are inserted into the slots 91a and 92a, respectively. The protrusion 20a after insertion may lie within wall 46a and the protrusion 20b after insertion may lie within wall 46b of the device 30. The protrusions 20a and 20b may be held in the slots 91a and 92a, in the position of FIG. 2 by friction, in a snap fit manner, or in any other known manner.

After the device 30 is properly attached to the device 10 as shown by FIG. 2, an individual would then use his or her hands to grasp, grab, or grip the member or handle 14. The individual would place the apparatus 1 directly over a cake, such as the cake 80, such as shown in FIG. 2. The individual would make sure that the device 30 is properly aligned with respect to the cake 80 so that the perimeter wall 30a will surround a perimeter wall 80a of the cake 80. While keeping the device 30 in this alignment with respect to the cake 80, the individual would push down and/or apply pressure on the apparatus 1, in the direction D, to cause the device 30 to cut through the cake 80. The device 30 will cut the cake 80 into eight substantially equal pieces corresponding to sections 36a-36h. Finally, the individual would lift up the apparatus 1, off or out of the cake 80, in a direction opposite direction D, to reveal a cake cut into eight substantially equal slices.

The apparatus 1 can be used on a portion of a whole cake, for example larger than cake 80, to cut a portion of a whole cake into a plurality of pieces.

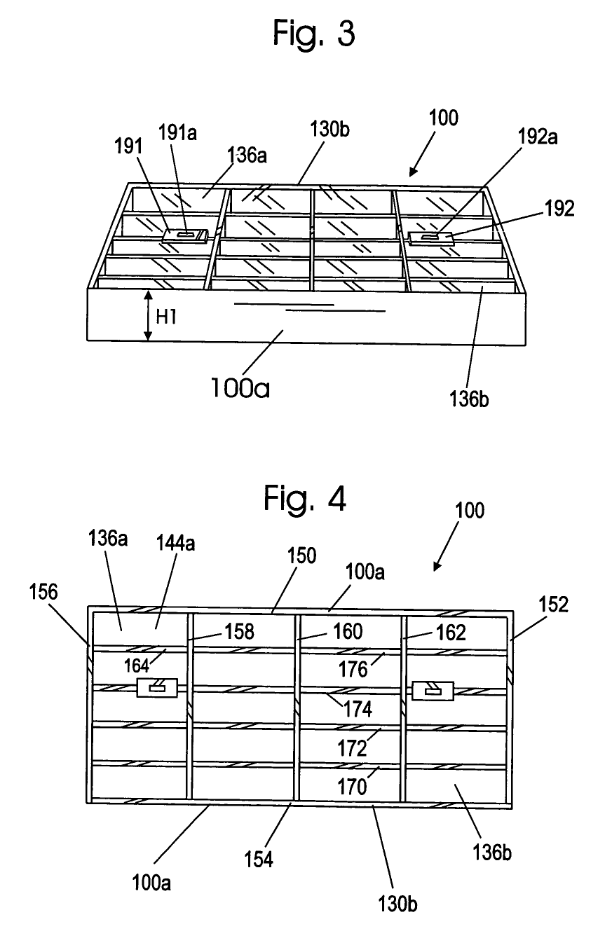

FIG. 3 shows a perspective view of a device 100 in accordance with another embodiment of the present invention. The device 100 includes brackets 191 and 192, which include slots 191a and 192a. The brackets 191 and 192 are fixed to wall 174. The device 100, can be used in place of the device 30. The device 100 can be attached to the handle device 10 of FIG. 1, via brackets 191 and 192 and protrusions 20a and 20b, respectively, similar to the manner in which the device 30 is shown attached to the device 10 in FIG. 1. I.e. the protrusions 20a and 20b would be inserted into the slots 191a and 192a to attach the handle device 10 to the device 100. The device 100 is particularly useful for cutting rectangular cakes into a plurality of pieces, each of which may be substantially the same size.

The device 100 is shaped in the form of a rectangle. The device 100 includes a plurality of sections, such as section 136a and 136b. The device 100 includes twenty sections as shown in FIG. 3. Each section is substantially the same and for that reason only section 136a will be described. Section 136a is bound by walls 150, 156, 164, and 158. The walls 150 and 156 may be part of the overall outer perimeter wall 100a. The section 136a includes a rectangular opening 144a. The apparatus 100 also includes walls 152, 154, 160, 162, 176, 174, 172, and 170, shown by FIG. 4.

In operation, an individual can detach the device 30 from the device 10. The individual may then attach the device 100 to the first device 10 by inserting the protrusions 20a and 20b into the slots 191a and 192a, respectively. The individual may then place a combination of the device 10 and the device 100 over a cake, such as a rectangular cake, and may press downwards to cut the cake into a plurality of pieces corresponding to section 136a, 136b and the other similar sections. In one embodiment, as shown by FIG. 3 and FIG. 4, the pieces, would be substantially the same size and shape, since the twenty sections including section 136a, have the same size and shape.

The perimeter wall 100a of the device 100 may be about two inches in height, H1, thirteen inches in width and nine inches in length.

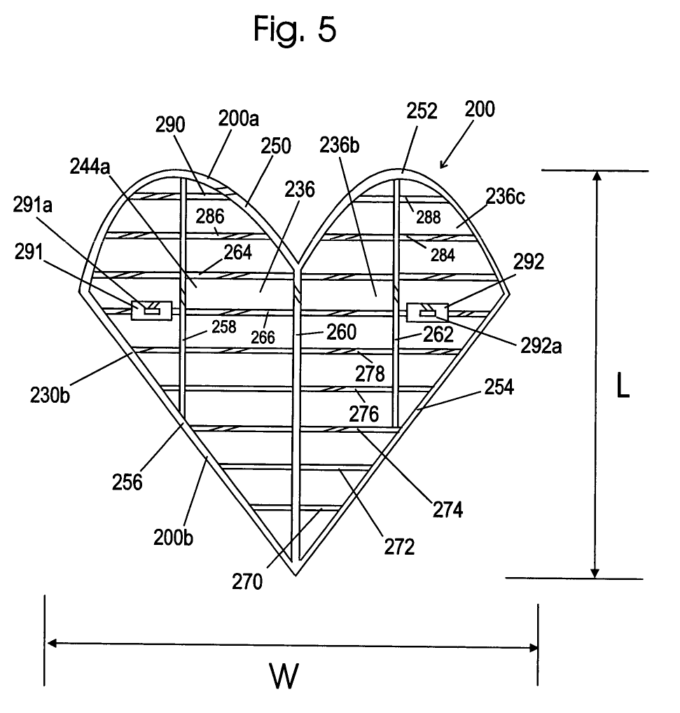

FIG. 5 shows a top view of a device 200 in accordance with another embodiment of the present invention. The device 200 includes an outer perimeter wall 200a, which may be comprised of walls 250, 252, 254, and 256. The device 200 also includes walls 258, 260, 262, 264, 266, 270, 272, 274, 276, 278, 284, 286, 288, and 290. The device 200 also includes brackets 291 and 292 which include slots 291a and 292a, respectively. The device 200 may be used in placed of the device 30 and may be attached to the handle device 10 by inserting the protrusions 20a and 20b of the handle device 10 into the slots 291a and 292a, respectively, of the device 200 in a manner similar to the manner in which the device 30 was attached to the device 10 in FIG. 2.

The device 200 is similar to the device 100 and the device 30, with the exceptions that the device 200 is heart shaped (instead of rectangular or circular) and the device 200 has a plurality of sections, not all of which are uniform in size and shape. The device 200 includes sections 236a and 236b, which are the same, size and shape. However the device 200 also includes section 236c and other sections, which are not the same size and shape as section 236a.

In operation, an individual can detach the device 30 from the device 10. The individual can then attach the device 200 to the device 10. The individual would insert the protrusions 20a and 20b into the brackets 291a and 292a, respectively. The device 200 should be attached to the device 10 so that the axis A of the members 14 and 18 is perpendicular to the plane in which a top edge 230b of the perimeter wall 200a resides. When, alternatively, the device 100 or the device 30 are used, the device 100 or the device 30 should also be attached so that the axis A, shown in FIG. 1, is perpendicular to the planes in which the top edges 130b and 30b reside.

The individual can then push down on the handle 14 in the direction D to cause a cake, such as cake 80 to be cut into pieces corresponding to heart shaped device 200. The cake 80 may be replaced by a heart shaped cake, which can be surrounded by the perimeter wall 200a of the device 200.

The devices 10 and 30 and devices 100 and 200 may be made of heavy metal or heavy plastic to allow for easy cutting of a cake. The perimeter walls 30a, 100a, and 200a may have a height of H1, which is shown for 100a in FIG. 2, which may be five and one half inches to six and one half inches, however, the height H1, may be adapted to be substantially equal to the height of a particular cake.

The heart shaped device 200 may have a width W which may be eight inches and a length L which may be twelve inches.

The inner diameter D1 of the device 30 for a circular cake cut, may be eight to ten inches. The brackets 91, 191, and 291 may be substantially the same. The brackets 92, 192, and 292 may be substantially the same. The brackets 91 and 92 may be spaced apart a standard distance. The brackets 191 and 192 may be spaced apart the same standard distance. The brackets 291 and 292 may be spaced apart the same standard distance. The standard distance allows the handle device 10 to be connected to any of the devices 30, 100, or 200 by inserting protrusions 20a and 20b into the appropriate slots of the appropriate brackets.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first device comprised of a plurality of sections, the first device including a first perimeter wall within which the plurality of sections are located and which defines a shape of the first device;
a second device, which includes a handle;
wherein the second device can be attached to or detached from the first device;
and wherein when the first device is attached to the second device, the first device is placed and aligned over a cake, and pressure is applied downwards on the top of the cake via the second device to the first device, the first device cuts the cake into a plurality of pieces corresponding to the plurality of sections.

2. The apparatus of claim 1 wherein
the plurality of sections are substantially the same size and shape.

3. The apparatus of claim 1 further comprising
a third device comprised of a plurality of sections, the third device including a second perimeter wall within which the plurality of sections of the third device are located and which defines a shape of the third device;
wherein the third device can be attached to or detached from the first device; and
wherein the shape of the first device is different from the shape of the third device.

4. The apparatus of claim 1 wherein
the first device has a circular shape.

5. The apparatus of claim 1 wherein
The first device has a rectangular shape.

6. The apparatus of claim 3 wherein
the first device has a circular shape; and
the third device has a rectangular shape.

7. The apparatus of claim 1 wherein
the first device includes a first slot; and
the second device includes a first protrusion; and
wherein the first device can be attached to the second device by inserting the first protrusion into the first slot.

8. The apparatus of claim 7 wherein
the first device includes a second slot; and
the second device includes a second protrusion;
wherein the first device can be attached to the second device by inserting the first and second protrusions into the first and second slots, respectively.

9. The apparatus of claim 3 wherein
the first device includes a first slot;
the second device includes a first protrusion; and
the third device includes a second slot;
wherein the first device can be attached to the second device by inserting the first protrusion into the first slot; and
wherein the third device can be attached to the second device by inserting the first protrusion into the second slot.

10. The apparatus of claim 9 wherein
the first device includes a third slot;
the second device includes a second protrusion; and
the third device includes a fourth slot;
wherein the first device can be attached to the second device by inserting the first and the second protrusions into the first and the third slots, respectively; and
wherein the third device can be attached to the second device by inserting the first and the second protrusions into the second and the fourth slots, respectively.

11. A method comprising the steps of
attaching a first device comprised of a plurality of sections to a second device, wherein the first device includes a first perimeter wall within which the plurality of sections are located and which defines a shape of the first device;
wherein the second device includes a handle;
placing a combination of the combination of the first device and the second device over a first cake and aligning the combination of the first device and the second device over the first cake; and
applying pressure downwards on the top of the first cake via the second device to the first device, while the combination of the first and second device is aligned over the first cake, so that the first device cuts the first cake into a plurality of pieces corresponding to the plurality of sections.

12. The method of claim 11 further comprising
detaching the first device from the second device;
attaching a third device comprised of a plurality of sections to the second device, wherein the third device includes a second perimeter wall within which the plurality of sections of the third device are located and which defines a shape of the third device;
placing a combination of the third device and the second device over a second cake and aligning the combination of the third device and the second device over the second cake; and
applying pressure downwards on the top of the second cake via the second device to the third device, while the combination of the second and third device is aligned over the second cake, so that the third device cuts the second cake into a plurality of pieces corresponding to the plurality of sections; and
and wherein the shape of the first device is different from the shape of the third device.

13. The method of claim 11 wherein
the first device has a circular shape.

14. The method of claim 11 wherein
the first device has a rectangular shape.

15. The method of claim 12
the first device has a circular shape; and
the third device has a rectangular shape.

16. The method of claim 12 further comprising
inserting a protrusion of the second device into a slot of the first device in order to attach the first device to the second device.

17. The method of claim 13 further comprising
inserting a protrusion of the second device into a slot of the first device in order to attach the first device to the second device.
inserting a protrusion of the second device into a slot of the third device in order to attach the third device to the second device.
